(19) United States
(12) Patent Application Publication
(10) Pub. No.: US 2002/0098301 A1
(43) Pub. Date: Jul. 25, 2002

(54) Foil covered figurine and method of manufacturing thereof

(76) Inventor: Pedro F. Garcia, Atlanta, GA (US)

Correspondence Address: GARDNER GROFF & MEHRMAN, P.C., PAPER MILL VILLAGE, BUILDING 23, 600 VILLAGE TRACE, SUITE 300, MARIETTA, GA, 30067, US

(21) Appl. No.: 10/047,316

(22) Filed: Jan. 14, 2002

Related U.S. Application Data
(60) Provisional application No. 60/261,594, filed on Jan. 12, 2001.

(51) Int. Cl. A01N 3/00

(52) U.S. Cl. 428/27

(57) ABSTRACT

A relatively moderate size to large size figurine and the production thereof is described. The figurine is provided with a slightly wrinkled, high sheen exterior surface. This gives the product a high quality look and allows for natural variations in the surface finish. The figurine is covered with tinted foil, which provides for a high-quality ornamental appearance. The figurine generally includes first and second half-shell sections that form an inner shell when joined. The inner shell defines the shape of the figurine. The first and second half-shell sections are formed from layering a plurality of material strips. The figurine also includes an exterior foil surface that covers and is fixedly attached to the inner shell.

### CROSS REFERENCE TO RELATED APPLICATION

This application claims the priority benefit of U.S. Provisional Patent Application No. 60/261,594 filed on Jan. 12, 2001, which is hereby incorporated by reference in its entirety.

### TECHNICAL FIELD

The present invention relates generally to figurines, and more particularly, to a foil covered figurine.

### BACKGROUND OF THE INVENTION

With the growing popularity of figurines, the type, size, and composition of figurines have varied. For example, some figurines may be only several inches tall while other figurines may be as tall as several feet. Generally, a lay-up process, such as paper mache, is used in forming many of the larger sizes of these figurines. After the figurine is formed, additional details as well as color can be added. Usually this color and these details are added using water-based colors or enamel. While this technique is feasible, it produces a figurine with a dull finish.

Smaller figurines can be made in more automated manners, such as by plastic injection molding. However, for larger figurines this becomes impractical because of the typically high cost of production tooling for large figurines and because of typically smaller sales quantities.

Despite the development in the area of figurines, conventional manufacturing techniques often result in a dull finish. Thus a need still exists for a moderate-to-large figurine and corresponding method of manufacturing that effectively produces high-gloss and cost efficient figurines.

### SUMMARY OF THE INVENTION

The present invention is directed to relatively moderate size to large size figurines and the production thereof. The figurines are provided with a slightly wrinkled, high sheen exterior surface. This gives the product a high quality look and allows for natural variations in the surface finish. The figurines are covered with tinted foil, which provides for a high-quality ornamental appearance.

The figurine generally comprises first and second half-shell sections that form an inner shell when joined. The inner shell defines the shape of the figurine. The first and second half-shell sections are formed from layering a plurality of material strips. The figurine also includes an exterior foil surface that covers and is fixedly attached to the inner shell.

In another form, the invention is a method of manufacturing figurines using a hand laid up process. Material strips are layered to form first and second sections of an inner shell. The first section is joined to the second section. The juncture of the first section and the second section is obscured. The inner shell is covered with several foil strips that form an exterior surface. The foil strips are tinted. In one form, the foil strips are tinted prior to application to the inner shell. In another form, the foil strips are applied to the inner shell and then tinted.

In view of the foregoing, it will be appreciated that a figurine and associated method of manufacturing, according to the present invention, avoids the drawbacks of prior systems. The specific techniques and structures employed by the invention to improve over the drawbacks of the prior systems and accomplish the advantages described herein will become apparent from the following detailed description of the embodiments of the invention and the appended drawings and claims.

### BRIEF DESCRIPTION OF THE DRAWINGS

FIG. 1 is a depiction of an exemplary medium to large size figurine in accordance with the present invention and having a hollow inner shell coated with foil.

FIG. 2 is a schematic view illustrating the lay up of individual half shells of the figurine of FIG. 1.

FIG. 3 is a schematic view illustrating the half shells of FIG. 2 being brought together to form a seam that is obscured with additional lay up material.

FIG. 4 is schematic view of the figurine of FIG. 3 illustrating the final touch up of the figurine shell with lay up strips.

FIG. 5 is a schematic view of the figurine of FIG. 4 illustrating covering the laid up shell with foil that ultimately results in the finished figurine of FIG. 1.

### DETAILED DESCRIPTION OF THE EMBODIMENTS

In describing the embodiments of the present invention, specific terminology is employed for the sake of clarity. The invention, however, is not intended to be limited to the specific terminology so selected.

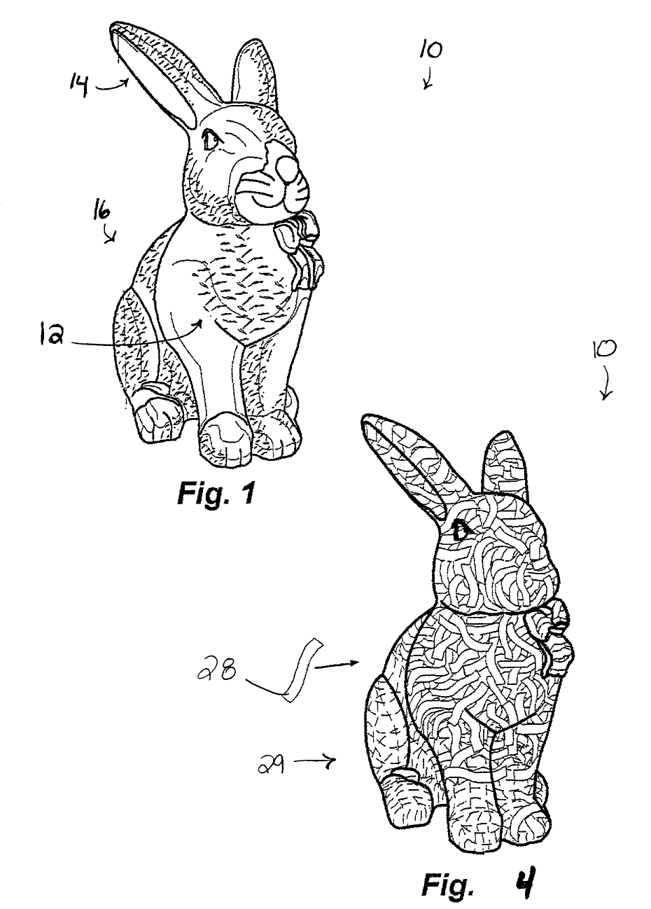

FIG. 1 is a depiction of an exemplary medium to large size figurine 10 in accordance with the present invention having a hollow inner shell coated with foil. This figurine can vary in size from several inches to several feet. NOTE: IS THIS RANGE CORRECT? For example, the figurine 10 could be between one to four feet tall. In addition, this figurine can have generally textured areas, or wrinkles, 12 that give figurine a more natural look. For example, the wrinkles 12 around the rabbit's breast makes the rabbit look more natural. In addition, the foil coating can be tinted in a variety of colors. For example, the inner ear 14 could be tinted a different color from the body 16. Together, the color, wrinkles, and glossy finish produce an appealing, yet low cost figurine. Consequently, this figurine is more marketable and manufacturers can reap the financial benefits of its low-cost production.

FIG. 2 is a schematic view illustrating the lay up of individual half shell sections 20, 22 of the figurine 10. When these sections are joined, they form a generally hollow inner shell. Layering strips of material can form each of these sections. For example, the sections 20,22 can be formed using paper mache. When the paper mache hardens, the inner shell is formed. The type of figurine can dictate the contour of the shell. For example, the contours of the sections 20, 22 can form a rabbit, as shown, a bear, a dog, or some other suitable object. Instead of paper mache, the section 20 and the sections 22 can be formed using a fiberglass mat or some other suitable lay up technique.

FIG. 3 is a schematic view illustrating the half shell sections 20, 22 being brought together to form a seam 24. Any one of several adhesives, such as glue, can be used in joining these sections together. Generally the seam 24 forms at the junction of the section 20 and the section 22. Applying material strips 26 can obscure the seam 24. The material strips 26 can be of the same type as the material strips used in forming the section 20 and the section 22. For example, the material strip 26 can be a strip of paper mache if the section 20 was formed using paper mache. In an alternative embodiment, the seam 24 is not obscured with material strips 26.

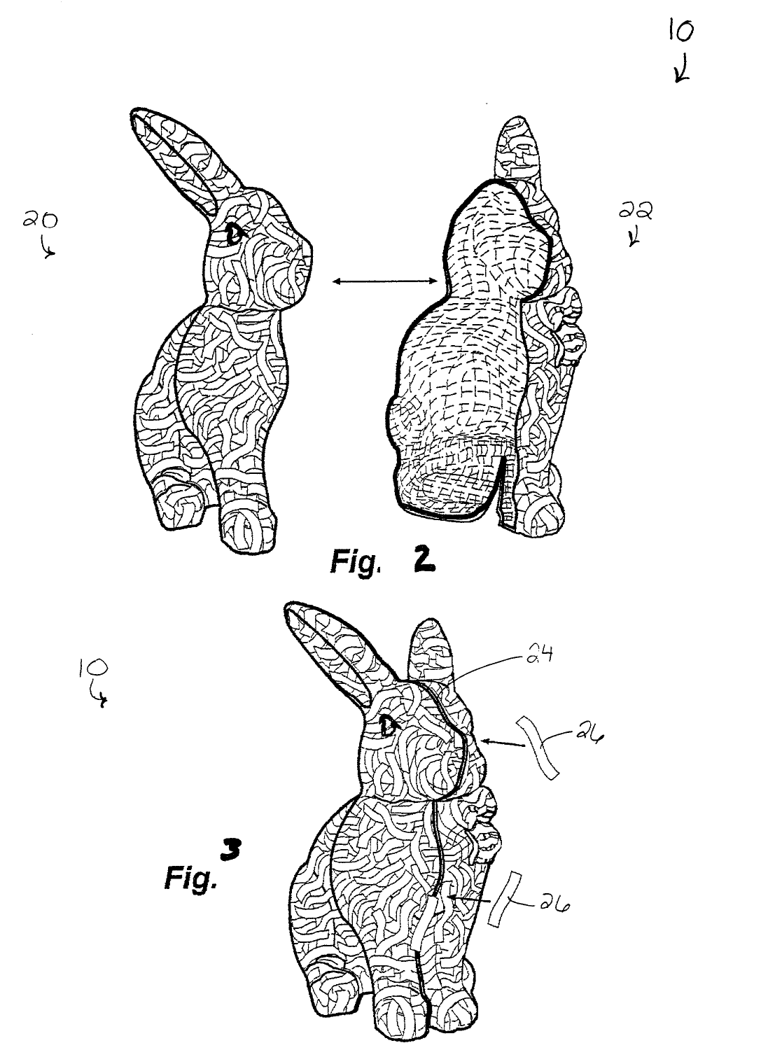

FIG. 4. is a schematic view of the figurine 10 illustrating the final touch up of the figurine shell with lay up strips 28. For example, the strips 28 can give definition to the hind leg 29. The strips 28 can be of the same type as the strips 26 or maybe different. For example, the strips 28 can be thicker than the strips 26, which could allow more definition using fewer strips. That is, fewer strips can be used in further defining the hind leg.

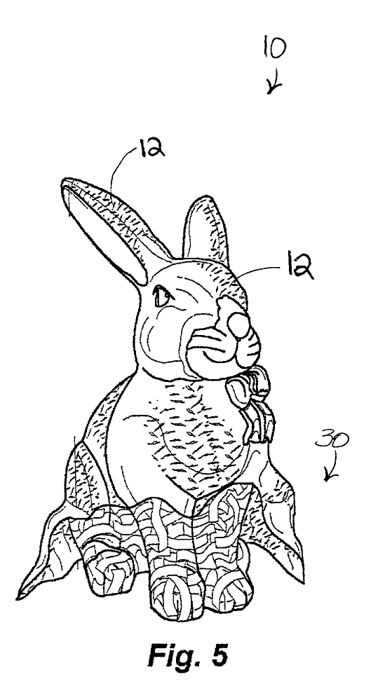

FIG. 5 is a schematic view of the figurine 10 illustrating covering the laid up shell with an exterior foil surface 30 that ultimately results in the finished figurine 10. In one embodiment, an adhesive on the underside of this foil surface can securely attach it to the figurine. This covering can be a thin sheet of metal, such as aluminum foil. Alternatively, several aluminum pieces can form the covering 30, which facilitates better covering of this figurine. After overlaying this figurine with the glossy foil covering 30, a machine can secure this covering around the figurine 10 by squeezing. This squeezing can produce wrinkles 12 in portions of the glossy covering 30 as described with reference to FIG. 1. To add color, a manufacturer can tint the covering 30. For example, a manufacturer can tint the figurine 10 by spray-painting this covering purple.

To produce the figurine 10, a method of manufacturing can be used. In one step, strips of material can be laid up on a mold. The mold could be in the shape of a rabbit, giraffe, person, or some other suitable shape. After the strips harden, the mold can be removed. The remaining structure is the inner shell of the figurine. If the inner shell is formed in pieces, an adhesive can join these pieces together. Subsequently, additional material strips can obscure the junction of the inner shell pieces. Finally, the inner shell can be covered with foil strips. These foil strips can form a glossy exterior covering, which can be tinted. This tinting can occur either before applying the glossy covering or after the glossy covering is applied.

In view of the foregoing, it will be appreciated that present invention provides a figurine and associated method. While the invention has been disclosed in preferred forms for illustration purposes, those skilled in the art will readily recognize that many modifications, additions, and deletions can be made therein without departing from the spirit and scope of the invention as set forth in the following claims.

1. A figurine comprising:
first and second half-shell sections that form an inner shell when joined and define the shape of the figurine, wherein the first and second half-shell sections are formed from layering a plurality of material strips; and
an exterior foil surface covering and fixedly attached to the inner shell, said exterior foil surface being at least slightly wrinkled.

2. A figurine as claimed in claim 1 wherein the material strips comprise paper mache.

3. A figurine as claimed in claim 1 wherein the material strips comprise a fiberglass mat.

4. A figurine as claimed in claim 1 wherein the first and second half-shell sections are hollow.

5. A figurine as claimed in claim 1 wherein the exterior foil surface comprises a plurality of strips.

6. A figurine as claimed in claim 1 wherein the exterior surface is tinted.

7. A method of manufacturing figurines using a hand laid up process comprising the steps of:
layering material strips to form first and second sections of an inner shell;
joining the first section to the second section;
obscuring the juncture of the first section and the second section;
covering the inner shell with a plurality of foil strips that form an exterior surface; and
tinting the exterior surface.

8. A method as claimed in claim 7 wherein the tinting step is completed after the covering step.

9. A method as claimed in claim 7 wherein the tinting step is completed before the covering step.

10. A method as claimed in claim 7 further comprising adding additional material strips to the inner shell that further define features of the figurine.

11. A method as claimed in claim 7 the covering step includes forming wrinkles in the exterior surface.
